(19) United States
(12) Patent Application Publication
(10) Pub. No.: US 2019/0213075 A1
(43) Pub. Date: Jul. 11, 2019

(54) MEMORY SYSTEM

(71) Applicant: SK hynix Inc., Icheon-si Gyeonggi-do (KR)

(72) Inventor: Do Hun KIM, Hwaseong-si Gyeonggi-do (KR)

(73) Assignee: SK hynix Inc., Icheon-si Gyeonggi-do (KR)

(21) Appl. No.: 16/152,170

(22) Filed: Oct. 4, 2018

(30) Foreign Application Priority Data
Jan. 11, 2018 (KR) 10-2018-0003747

(51) Int. Cl. G06F 11/10; G06F 3/06

(52) U.S. Cl. CPC G06F 11/1076; G06F 3/0673; G06F 3/0659; G06F 3/0619

(57) ABSTRACT

A memory system may include a first memory and a second memory. The second memory may have a characteristic different from the first memory. The memory system may include a data attribute determination circuit configured to determine an attribute on data to be stored. The memory system may include a memory selection circuit configured to selectively store parity information on the data in the first memory or the second memory, based on the attribute of the data.

### CROSS-REFERENCES TO RELATED APPLICATION

The present application claims priority under 35 U.S.C. § 119(a) to Korean application number 10-2018-0003747, filed on Jan. 11, 2018, in the Korean Intellectual Property Office, which is incorporated herein by reference in its entirety.

### BACKGROUND

### 1. Technical Field

Various embodiments generally relate to a memory system, and, more particularly, to a memory system including a controller and nonvolatile memory device.

### 2. Related Art

A memory system may be configured to store data received from an external device, in response to a write request from the external device. Also, the memory system may be configured to provide stored data to the external device, in response to a read request from the external device. External device as an electronic devices capable of processing data include, for example, computers, digital cameras, and mobile phones. The memory system may be integrated with the external device, or may be manufactured separate from and operably coupled to the external device.

A memory system using a memory device has an advantage in that, because there are no moving mechanical parts, stability and durability are favorable, and power consumption is low. Memory systems having such advantages include a universal serial bus (USB) memory device, memory cards having various interfaces, a universal flash storage (UFS) device, and a solid state drive (SSD).

### SUMMARY

In an embodiment, a memory system may be provided. The memory system may include a memory control unit. The memory system may include a first memory. The memory system to may include a second memory having a characteristic different from the first memory. The memory system may include a data attribute determination circuit configured to determine an attribute of data to be transmitted through the memory control unit. The memory system may include and a memory selection circuit configured to selectively store a parity information on the data in the first memory or the second memory, based on the attribute of the data.

In an embodiment, a memory system may be provided. The memory system may include a memory control unit. The memory system may include a first memory. The memory system may include a second memory having a characteristic different from the first memory, and configured to buffer data to be transmitted through the memory control unit. The memory system may include a parity generator configured to generate a parity information for the data. The memory system may include a control unit configured to control the parity generator to store the parity information in any one of the first memory and the second memory. The control unit may include a data attribute determination circuit configured to determine an attribute of the data and a memory selection circuit configured to select any one of the first memory and the second memory as a memory in which the parity information is to be stored, based on the attribute of the data.

In an embodiment, a memory system may be provided. The memory system may include a first memory. The memory system may include a second memory having a data transmission to rate lower than the first memory, and configured to buffer data to be transmitted through the memory control unit. The memory system may include a parity generator configured to generate a parity information for the data. The memory system may include a data attribute determination circuit configured to determine an attribute of is the data. The memory system may include a memory selection circuit configured to selectively store the parity information in the first memory or the second memory, based on the attribute of the data. The memory selection circuit may store the parity information in the second memory when the data is cold data or rewrite data.

### BRIEF DESCRIPTION OF THE DRAWINGS

FIG. 1 is a block diagram illustrating a representation of an example of the configuration of a memory system in accordance with an embodiment.

FIG. 2 is a block diagram illustrating a representation of an example of the configuration of the memory system which interfaces with a host device.

FIGS. 3 to 5 are representations of examples of diagrams to assist in the explanation of a process in which a parity information is stored in a memory in correspondence to a write request of a host.

FIGS. 6 and 7 are representations of examples of diagrams to assist in the explanation of a process in which a parity information is stored in a memory in a garbage collection process.

FIG. 8 is a representation of an example of a diagram to assist in the explanation of a process in which a parity information is stored in another memory when a sudden power-off occurs while the parity information is stored in a memory in a garbage collection process.

FIG. 9 is a diagram illustrating a representation of an is example of a data processing system including a solid state drive (SSD) in accordance with an embodiment.

FIGS. 10 and 11 are diagrams illustrating representations of examples of data processing systems each including a memory system in accordance with embodiments.

FIG. 12 is a diagram illustrating a representation of an example of a network system including a memory system in accordance with an embodiment.

FIG. 13 is a block diagram illustrating a representation of an example of a nonvolatile memory device included in a memory system in accordance with an embodiment.

### DETAILED DESCRIPTION

In the present teaching, advantages, features and methods for achieving them will become more apparent after a reading of the following examples of embodiments taken in conjunction with the drawings. The present teaching may, however, be embodied in different forms and should not be construed as being limited to the embodiments set forth herein. Rather, these embodiments are provided to describe the present teaching in detail to the extent that a person skilled in the art to which the teaching pertains can easily enforce the technical concept of the present teachings.

It is to be understood herein that embodiments are not limited to the particulars shown in the drawings and that the drawings are not necessarily to scale and in some instances proportions may have been exaggerated in order to more clearly depict certain features. While particular terminology is used herein, it is to be appreciated that the terminology used herein is for the purpose of describing particular embodiments only and is not intended to limit the scope of the present teachings.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes ” and/or “including,” when used in this specification, specify the presence of at least one stated feature, step, operation, and/or element, but do not preclude the presence or addition of one or more other features, steps, operations, and/or elements thereof.

Hereinafter, a memory system will be described below with reference to the accompanying drawings through various examples of embodiments.

Various embodiments may be directed to a memory system which selectively determines a memory where a parity information is to be stored, depending on the attribute of data.

In the memory system according to the embodiments, since the parity information of data is stored selectively in memories having different characteristics, depending on the attribute of the data, it may be possible to efficiently use the memories.

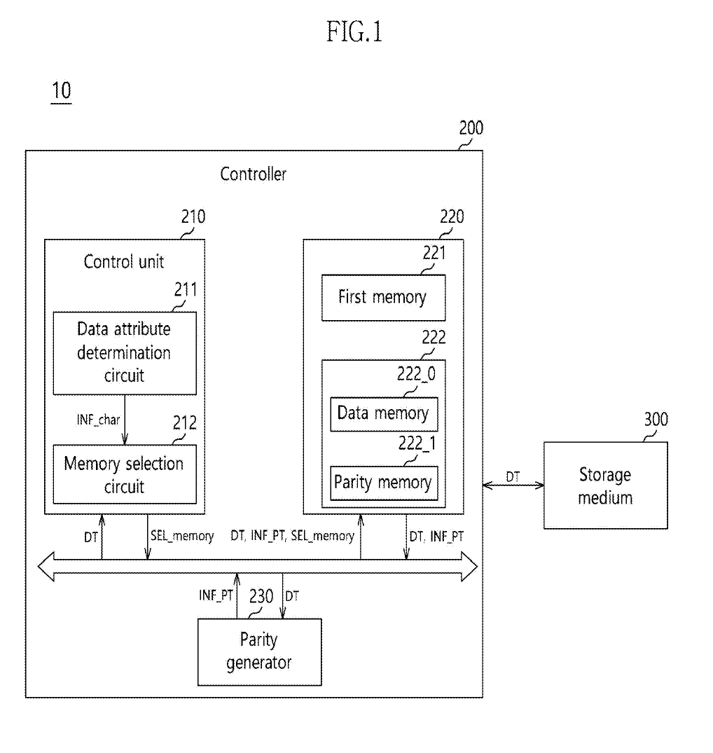

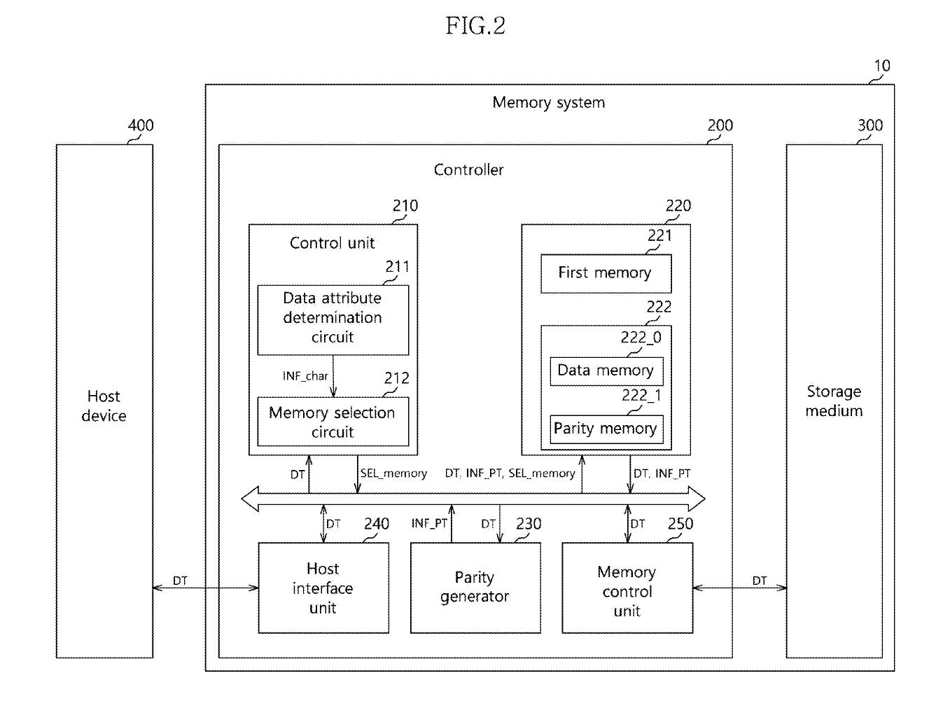

FIG. 1 is a block diagram illustrating a representation of an example of the configuration of a memory system in accordance with an embodiment, and FIG. 2 is a block diagram illustrating a representation of an example of the configuration of the memory system which interfaces with a host device. Hereunder, the configuration of a memory system 10 in accordance with the embodiment will be described with reference to FIGS. 1 and 2.

The memory system 10 in accordance with an embodiment may include a first memory 221, a second memory 222 which has a characteristic different from the first memory 221 and is configured to buffer data DT to be stored in a storage medium 300, a parity generator 230 which is configured to generate parity information INF_PT on the data DT, and a control unit 210 which controls the parity generator 230 to store the parity information INF_PT in any one of the first memory 221 and the second memory 222. The control unit 210 may include a data attribute determination circuit 211 which determines an attribute INF_char of the data DT and a memory selection circuit 212 which selects any one of the first memory 221 and the second memory 222 as a memory to store the parity information INF_PT, based on the attribute INF_char of the data DT. The memory selection circuit 212 may output a memory selection signal SEL_memory including information on a memory to store the parity information INF_PT, based on the attribute INF_char of the data DT determined from the data attribute determination circuit 211. Based on the parity information INF_PT generated in the parity generator 230 and the memory selection signal SEL_memory outputted from the memory selection circuit 212, the parity information INF_PT on the data DT may be stored selectively in the first memory 221 or the second memory 222.

The memory system 10 may include a controller 200 and the storage medium 300.

The memory system 10 may store data to be accessed by a host device 400 such as a mobile phone, an MP3 player, a laptop computer, a desktop computer, a game player, a TV, an in-vehicle infotainment system, and so forth.

The memory system 10 may be manufactured as any one of various kinds of storage devices according to a host interface meaning a transmission protocol with the host device 400. For example, the memory system 10 may be configured as any one of various kinds of storage devices such as a solid state drive (SSD), a multimedia card in the form of an MMC, an eMMC, an RS-MMC and a micro-MMC, a secure digital card in the form of an SD, a mini-SD and a micro-SD, a universal serial bus (USB) storage device, a universal flash storage (UFS) device, a Personal Computer Memory Card International Association (PCMCIA) card type storage device, a peripheral component interconnection (PCI) card type storage device, a PCI express (PCI-E) card type storage device, a compact flash (CF) card, a smart media card, a memory stick, and so forth.

The memory system 10 may be manufactured as any one among various kinds of package types. For example, the memory system 10 may be manufactured as any one of various kinds of package types such as a package-on-package (POP), a system-in-package (SIP), a system-on-chip (SOC), a multi-chip package (MCP), a chip-on-board (COB), a wafer-level fabricated package (WFP) and a wafer-level stack package (WSP).

The controller 200 may include the control unit 210, a random access memory 220, the parity generator 230, a host interface unit 240 and a memory control unit 250.

The controller 200 may control the general operations of the memory system 10. The controller 200 may store data in the storage medium 300 in response to a write request transmitted from the host device 400, and may read data stored in the storage medium 300 and output the read data to the host device 400 in response to a read request transmitted from the host device 400. In order to store/read data, the controller 200 may access a nonvolatile memory device included in the storage medium 300, according to an interleaving scheme.

The controller 200 may store a plurality of data chunks in a super block which includes blocks having the same block offset among the plurality of blocks included in each of a plurality of storage mediums 300, and may store parity information generated for the plurality of data chunks, in the random access memory 220. As referred to herein, parity information may be based on a result of performing a logic calculation, for example, an exclusive-OR calculation, for a plurality of data chunks.

The controller 200 may divide, depending on the attribute of data to be stored in the storage medium 300, the random access memory 220 into regions where parity information for data is to be stored, and may determine a region to which parity information generated in the parity generator 230 is to be transmitted. The parity generator 230 may generate parity information corresponding to each of a plurality of blocks formed in the plurality of storage media 300. As the controller 200 divides, depending on the attribute of data, the random access memory 220 into regions where parity information is to be stored, it is possible to secure a sufficient space for storing parity information.

The control unit 210 may be configured by a micro control unit (MCU) or a central processing unit (CPU). The control unit 210 may process a request which is transmitted from the host device 400. In order to process the request, the control unit 210 may drive an instruction or algorithm of a code type, that is, a firmware (FW), loaded in the random access memory 220, and may control internal function blocks and the storage medium 300.

The control unit 210 may include the data attribute determination circuit 211 and the memory selection circuit 212. The data attribute determination circuit 211 may determine the attribute INF_char of data to be stored in the storage medium 300. According to an embodiment, the data attribute determination circuit 211 may is determine whether data DT to be stored in the storage medium 300 is host data or rewrite data. The host data may mean data which becomes the target of a write request of the host device 400 and has not been stored in the storage medium 300, and the rewrite data may mean data which has been stored in the storage medium 300 and then becomes the target of a background operation (for example, garbage collection or read reclaim). According to an embodiment, the data attribute determination circuit 211 may determine whether data DT to be stored in the storage medium 300 is hot data or cold data. The hot data may mean data of which read or write frequency is high, and the cold data may mean data of which read or write frequency is relatively low as compared to a reference. A reference (for example, a read or write frequency) for distinguishing hot data and cold data may be set and changed by the control unit 210.

The memory selection circuit 212 may select a memory where the parity information INF_PT on the data DT is to be stored, based on the attribute INF_char of the data DT determined by the data attribute determination circuit 211. For instance, the first memory 221 or the second memory 222 included in the random access memory 220 may be selected, and the first memory 221 and the second memory 222 may be memories which have different data transmission rates.

The random access memory 220 may store the firmware (FW) which is to be driven by the control unit 210. Also, the random access memory 220 may store data necessary for driving the firmware (FW), for example, metadata. That is to say, the random access memory 220 may operate as the working memory of the control unit 210.

The random access memory 220 may include a data memory 222_0 and a parity memory 222_1. The data memory 222_0 may temporarily store the data DT received from the host device 400 or the storage medium 300, and may transmit the data DT to the host device 400 or the storage medium 300. That is to say, the data memory 222_0 may play the role of buffering data. The parity memory 222_1 may receive and store the parity information INF_PT generated in the parity generator 230.

The host interface unit 240 may interface the host device 400 and the memory system 10. For instance, the host interface unit 240 may communicate with the host device 400 through any one of standard transmission protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-E) and universal flash storage (UFS), that is, by using a host interface.

The memory control unit 250 may control the storage medium 300 according to the control of the control unit 210. The memory control unit 250 may also be referred to as a memory interface unit. The memory control unit 250 may provide control signals to the storage medium 300. The control signals may include a command, an address, a control signal and so forth for controlling the storage medium 300. The memory control unit 250 may provide data DT to the storage medium 300 or may be provided with data DT from the storage medium 300.

The storage medium 300 may include a nonvolatile memory device, and the nonvolatile memory device may include a flash memory device such as a NAND flash and a NOR flash, an FeRAM (ferroelectric random access memory), a PCRAM (phase change random access memory), an MRAM (magnetic random access memory) or an ReRAM (resistive random access memory).

The storage medium 300 may be configured by a plurality of nonvolatile memory devices. Each of the nonvolatile memory devices may store the data chunk transmitted from the controller 200 according to the control of the controller 200, and may read stored data chunk and transmit the read data chunk to the controller 200 based on a transmission command of the controller 200.

The controller 200 may store the parity information INF_PT on the data DT to be stored in the storage medium 300, selectively in memories having different characteristics, depending on the attribute INF_char of the data DT. For instance, the first memory 221 may have a relatively higher data transmission rate than the second memory 222. A data transmission rate may mean the amount of data transmitted for a unit time. According to an embodiment, the attribute INF_char of data may be divided into data used in a request received from the host device 400 and data used in a background operation. For instance, the request received from the host device 400 may be a write request, and the background operation may be a garbage collection, wear leveling or read reclaim operation. For instance, the parity information INF_PT on the data used in the background operation exerting a small influence on the performance of the memory system 10 may be stored in the random access memory 220 configured by a DRAM. In this case, when compared to a scheme of storing the parity information INF_PT in only the random access memory 220 configured by an SRAM, the size of the SRAM may be minimized, and a space utilization efficiency may be improved as parity informations INF_PT are stored by being dispersed in memories.

The memory system 10 in accordance with an embodiment may include the first memory 221, the second memory 222 which has a data transmission rate relatively lower than the first memory 221 and is configured to buffer data DT to be stored in the storage medium 300, the parity generator 230 which is configured to generate the parity information INF_PT on the data DT, depending on the attribute INF_char of the data DT, and the control unit 210 which is configured to generate the memory selection signal SEL_memory and thereby store the parity information INF_PT selectively in the first memory 221 or the second memory 222. The control unit 210 may store the parity information INF_PT in the second memory 222 when the data DT is cold data or rewrite data. The rewrite data may mean data which is stored in a specific block of the storage medium 300 and is then transmitted to the controller 200. Also, the rewrite data may mean data which is transmitted again to the storage medium 300 after being transmitted from the storage medium 300 to the controller 200, to be rewritten in a region other than a region where the data is previously stored. For instance, the rewrite data may mean data which becomes a target of a garbage collection, wear leveling or read reclaim operation. However, the embodiment is not limited thereto, and the rewrite data may mean all data which are stored in specific blocks of the storage medium 300 and are then transmitted to the controller 200.

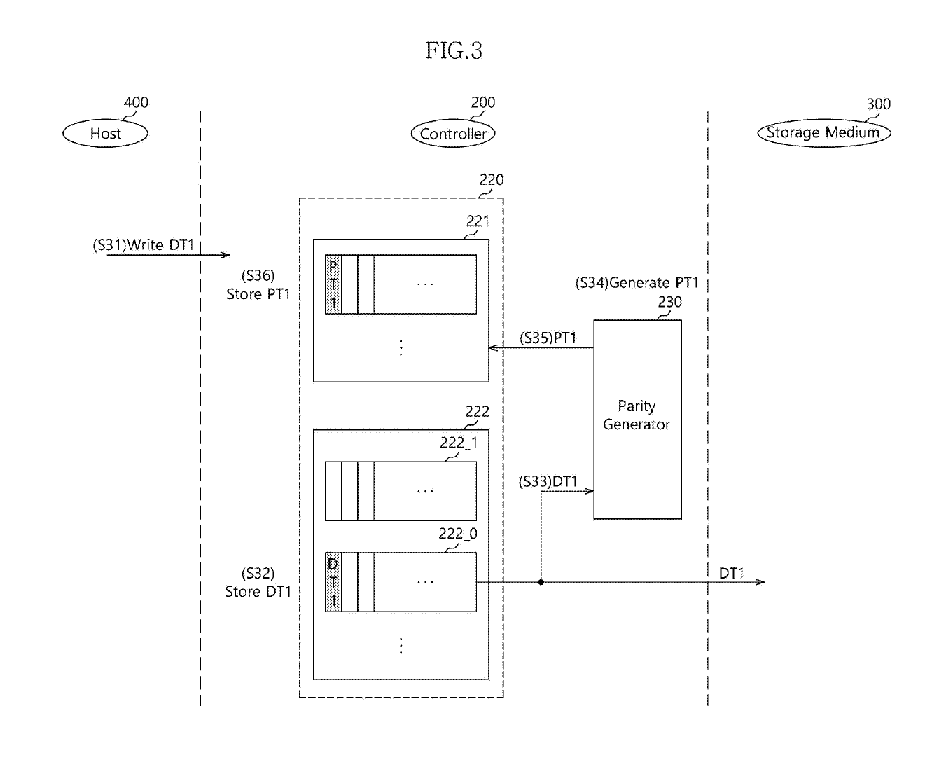

FIG. 3 is a representation of an example of a diagram to assist in the explanation of a process in which parity information is stored in a memory in correspondence to a write request of a host.

With reference to FIGS. 2 and 3, a process in which parity information is stored in the first memory 221 in correspondence to a write request of a host in accordance with an embodiment will be described below. For instance, the first memory 221 may be configured to include a memory having relatively faster access time or relatively higher bandwidth such as SRAM, and the second memory 222 may be configured to include a plurality of memories having relatively slower access time or relatively lower bandwidth such as DRAMs. However, the embodiments are not limited thereto, and other kinds of memory devices capable of storing data may be used.

At step S31, the controller 200 may receive a write request for first data DT1 from the host device 400.

At step S32, the first data DT1 received from the host device 400 may be stored in the second memory 222. For example, the second memory 222 may include the data memory 222_0 for temporarily storing the data received from the host device 400, and the first data DT1 received from the host device 400 may be stored in the data memory 222_0. That is to say, the data memory 222_0 may perform a buffering operation, and may temporarily store data to be transmitted to the host device 400 or the storage medium 300.

At step S33, the first data DT1 stored in the data memory 222_0 may be transmitted to the parity generator 230. As shown, the first data DT1 stored in the data memory 222_0 may be transmitted to the storage medium 300 by the control of the control unit 210, and the control unit 210 may obtain an attribute INF_char of the first data DT1 which is to be transmitted to the storage medium 300 and control the same first data DT1 to be transmitted to the parity generator 230.

At step S34, based on the first data DT1 received from the data memory 222_0, the parity generator 230 may generate first parity information PT1 on the first data DT1.

At step S35, the first parity information PT1 may be transmitted to the first memory 221, and, at step S36, the first parity information PT1 may be stored in the first memory 221. In other words, if the first data DT1 received by the controller 200 is based on the write command of the host device 400, the control unit 210 may control the first parity information PT1 on the first data DT1 to be stored in the first memory 221. In the present specification, host data may mean data which is the target of a write request received from the host device 400 and has not been stored in the storage medium 300.

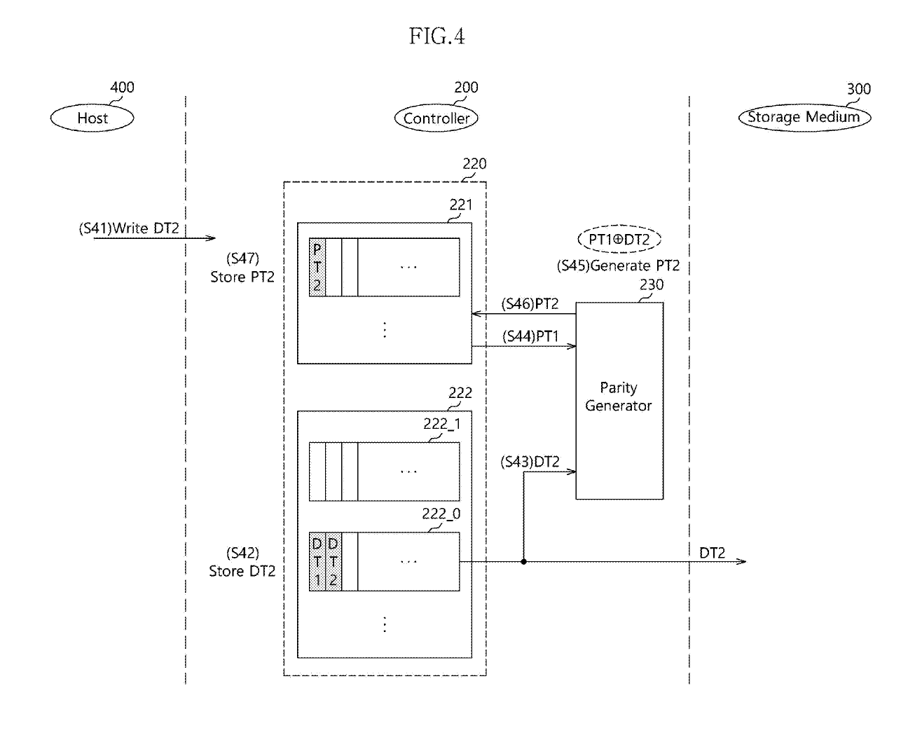

FIG. 4 is a representation of an example of a diagram to assist in the explanation of a process in which parity information is stored in a memory in correspondence to a write request of a host for hot data. For the sake of convenience in explanation, it is assumed that, as described above with reference to FIG. 3, first parity information PT1 on first data DT1 is stored in the first memory 221. With reference to FIGS. 2, 3 and 4, a process in which parity information is stored in a memory in correspondence to a write request of a host for hot data in accordance with an embodiment will be described below.

At step S41, a write request for second data DT2 may be received from the host device 400. The host device 400 may output the write request including the attribute of the second data DT2, that is, information on whether the second data DT2 is hot data or cold data. According to an embodiment, whether the data received from the host device 400 is hot data or cold data may be determined by the control unit 210. In FIG. 4, it is assumed that the second data DT2 received the host device 400 is hot data. Data of which read or write frequency is high may be defined as hot data, and data of which read or write frequency is relatively low may be defined as cold data. A reference for distinguishing hot data and cold data may be set and changed in the control unit 210 according to a request of the host device 400.

At step S42, the second data DT2 received from the host device 400 may be stored in the second memory 222. For example, the second data DT2 may be temporarily stored in the data memory 222_0 included in the second memory 222. While it is illustrated that the first data DT1 is stored in the data memory 222_0, the first data DT1 may be erased after being transmitted to the storage medium 300, not to be kept stored in the data memory 222_0.

At step S43, the second data DT2 stored in the data memory 222_0 may be transmitted to the parity generator 230. As shown, the second data DT2 stored in the data memory 222_0 may be transmitted to the storage medium 300 by the control of the control unit 210, and the control unit 210 may obtain an attribute INF_char of the second data DT2 which is to be transmitted to the storage medium 300 and control the same second data DT2 to be transmitted to the parity generator 230.

At step S44, the first parity information PT1 stored in the first memory 221 may be transmitted to the parity generator 230 by the control of the control unit 210. The first parity information PT1 may mean parity information on the first data DT1.

According to an embodiment, a sequence in which the parity generator 230 receives data and previous parity information may be changed. Namely, in FIG. 4, the sequence of the step S43 and the step S44 may be changed, and thus, the second data DT2 may be transmitted to the parity generator 230 after the first parity information PT1 is transmitted to the parity generator 230.

At step S45, based on the first parity information PT1 and the second data DT2, the parity generator 230 may generate second parity information PT2 on the first data DT1 and the second data DT2. The parity generator 230 may generate parity information based on a result of performing a logic calculation, for example, an exclusive-OR calculation, for data chunks.

At step S46, the second parity information PT2 generated in the parity generator 230 may be transmitted to the first memory 221, and, at step S47, the second parity information PT2 may be stored in the first memory 221. That is to say, if the second data DT2 is determined as hot data, the control unit 210 may control the second parity information PT2 to be stored in the first memory 221.

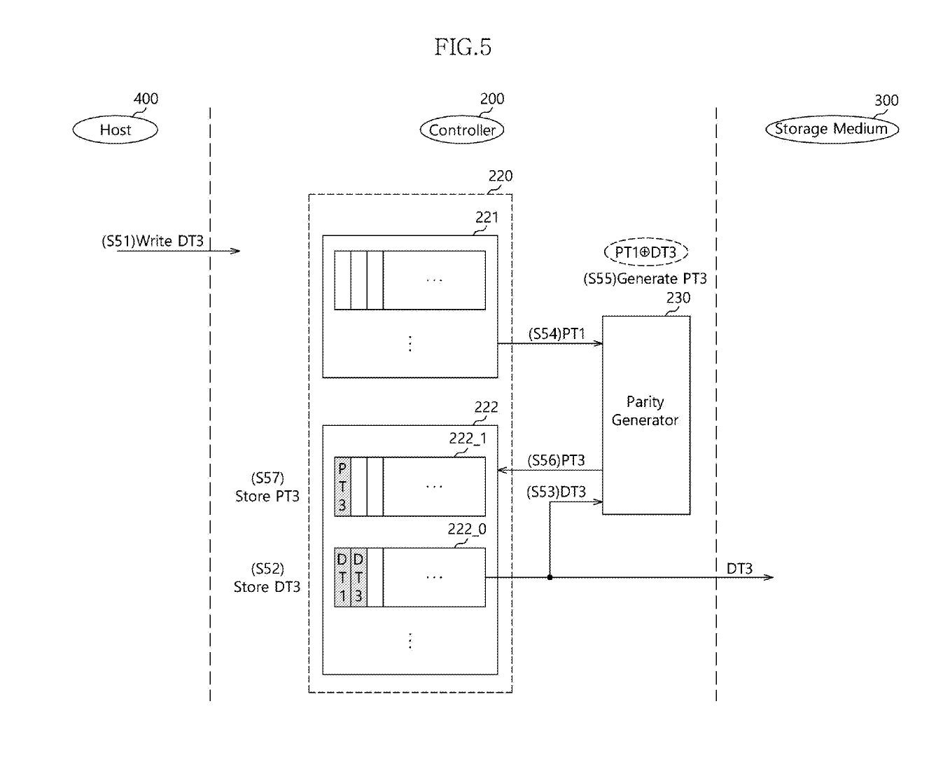

FIG. 5 is a representation of an example of a diagram to assist in the explanation of a process in which parity information is stored in a memory in correspondence to a write request of a host for cold data. It is assumed that, as described above with reference to FIG. 3, first parity information PT1 on first data DT1 is stored in the first memory 221. With reference to FIGS. 2, 3 and 5, a process in which parity information is stored in a memory in correspondence to a write request of a host for cold data in accordance with an embodiment will be described below.

At step S51, a write request for third data DT3 may be received from the host device 400. The host device 400 may output the write request including the attribute of the third data DT3, that is, information on whether the third data DT3 is hot data or cold data. According to an embodiment, whether the data received from the host device 400 is hot data or cold data may be determined by the control unit 210. In FIG. 5, it is assumed that the third data DT3 received the host device 400 is cold data by the request of the host device 400 or a result of the determination of the control unit 210.

At step S52, the third data DT3 received from the host device 400 may be stored in the second memory 222. For example, the data memory 222_0 may temporarily store the third data DT3. While it is illustrated that the first data DT1 is stored in the data memory 222_0, the first data DT1 may be erased after being transmitted to the storage medium 300, not to be kept stored in the data memory 222_0.

At step S53, the third data DT3 stored in the data memory 222_0 may be transmitted to the parity generator 230. The third data DT3 may be transmitted from the data memory 222_0 to the storage medium 300, and the control unit 210 may obtain an attribute INF_char of the third data DT3 which is to be transmitted to the storage medium 300 and control the same third data DT3 to be transmitted to the parity generator 230.

At step S54, the first parity information PT1 stored in the first memory 221 may be transmitted to the parity generator 230 by the control of the control unit 210. The first parity information PT1 may mean parity information on the first data DT1.

According to an embodiment, a sequence in which the parity generator 230 receives data and previous parity information may be changed. Namely, in FIG. 5, the sequence of the step S53 and the step S54 may be changed, and thus, the third data DT3 may be transmitted to the parity generator 230 after the first parity information PT1 is transmitted to the parity generator 230.

At step S55, based on the first parity information PT1 and the third data DT3, the parity generator 230 may generate a third parity information PT3 on the first data DT1 and the third data DT3. The parity generator 230 may generate parity information based on a result of performing a logic calculation, for example, an exclusive-OR calculation, for data chunks.

At step S56, the third parity information PT3 generated in the parity generator 230 may be transmitted to the second memory 222, and, at step S57, the third parity information PT3 may be stored in the second memory 222. For example, the second memory 222 may include the parity memory 222_1 which stores parity information, and the control unit 210 may control the third parity information PT3 to be stored in the parity memory 222_1 included in the second memory 222. That is to say, if the third data DT3 is determined as cold data, the control unit 210 may control the third parity information PT3 to be stored in the parity memory 222_1 of the second memory 222. While it is illustrated for the sake of convenience in explanation that the first parity information PT1 stored in the first memory 221 is erased, the first parity information PT1 stored in the first memory 221 may remain separately from the fact that the third parity information PT3 is stored in the second memory 222. In this case, as the first parity information PT1 and the third parity information PT3 are stored in different regions, the reliability of data recovery may be improved.

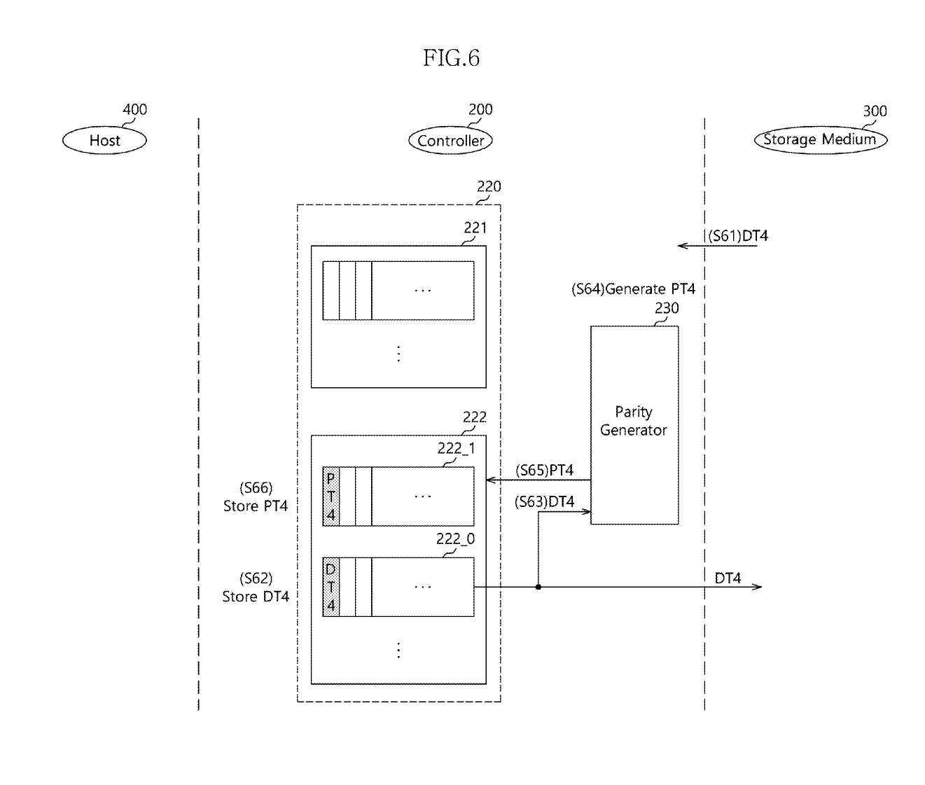

FIG. 6 is a representation of an example of a diagram to assist in the explanation of a process in which parity information is stored in a memory in a garbage collection process. While FIGS. 6 to 8 illustrate as an example a case where a parity information is stored in the second memory 222 in a garbage collection operation, it is to be noted that the embodiment is not limited to the garbage collection operation, and the same principle may be applied to a background operation that may include a garbage collection operation, a wear leveling operation or a read reclaim operation. Hereunder, with reference to FIGS. 2 and 6, a process in which parity information is stored in a memory in a garbage collection process will be described.

A garbage collection operation is caused since the storage medium 300 as a nonvolatile memory device may perform read/write of data by the unit of page but performs erase of data by the unit of block. In other words, due to the characteristics of a nonvolatile memory device, when updating the content of data stored in a specific page of a specific block included in the nonvolatile memory device, a scheme is used in which the data is not rewritten in the specific page, the specific page is invalidated and an updating content is newly written in a free page of a specific block or another free block. The data of the specific page which is invalidated is referred to as garbage data because it is unused data. In the case where the number of invalidated pages in the specific block is increased to be equal to or greater than a predetermined number as updates of data are performed, all the data of the invalid pages included in the specific block should be deleted. In this regard, an operation of copying the data of the valid pages included in the specific block to delete all the invalid data included in the specific block and then erasing the specific block is referred to as a garbage collection operation.

At step S61, fourth data DT4 which is stored in a block as the target of garbage collection may be transmitted from the storage medium 300 to the controller 200, and, at step S62, the fourth data DT4 may be stored in the second memory 222. The second memory 222 may include the data memory 222_0 for temporarily storing the data received from the host device 400 or the storage medium 300. That is to say, the data memory 222..0 may perform a buffering operation, and may store data to be transmitted to the host device 400 or the storage medium 300.

At step S63, the fourth data DT4 stored in the second memory 222 may be transmitted to the parity generator 230. As shown, the fourth data DT4 may be transmitted to the storage medium 300 by the control of the control unit 210, and the control unit 210 may obtain an attribute INF_char of the fourth data DT4 which is to be transmitted to the storage medium 300 and control the same fourth data DT4 to be transmitted to the parity generator 230.

At step S64, based on the fourth data DT4, the parity generator 230 may generate fourth parity information PT4 on the fourth data DT4.

As another embodiment, the fourth data DT4 transmitted from the storage medium 300 may not be stored in the data memory 222_0, and the parity generator 230 may receive the fourth data DT4 and then generate a fourth parity information PT4 on the fourth data DT4. In other words, the step S62 and the step S63 may be omitted.

At step S65, the generated fourth parity information PT4 may be transmitted to the second memory 222, and, at step S66, the fourth parity information PT4 may be stored in the second memory 222. For example, the second memory 222 may include the parity memory 222_1 which stores parity information, and the fourth parity information PT4 may be stored in the parity memory 222_1. In other words, if the fourth data DT4 is data as the target of an operation to be performed in a background, the control unit 210 may control the fourth parity information PT4 on the fourth data DT4 to be stored in the second memory 222. The operation to be performed in a background may be set or changed by the host device 400 or the control unit 210. As another embodiment, even in the case of data used in an operation to be performed in a background, if another data is stored in the second memory 222, the control unit 210 may control parity data to be stored in the first memory 221.

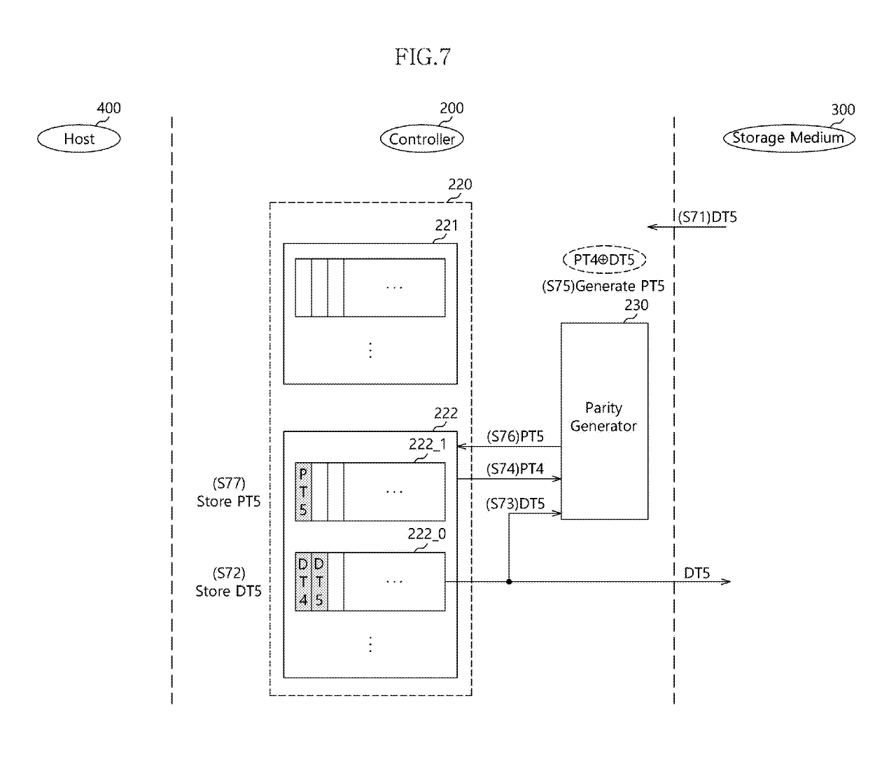

FIG. 7 is a representation of an example of a diagram to assist in the explanation of a process in which parity information is stored in a memory in a garbage collection process. It is assumed that, as described above with reference to FIG. 6, fourth parity information PT4 on fourth data DT4 is stored in the second memory 222. With reference to FIGS. 2, 6 and 7, a process in which the parity information of data as the target of garbage collection is stored in a memory in accordance with an embodiment will be described below.

At step S71, fifth data DT5 which is stored in a block as the target of garbage collection may be transmitted from the storage medium 300 to the controller 200, and, at step S72, the fifth data DT5 received from the storage medium 300 may be stored in the second memory 222. While it is illustrated that the fourth data DT4 is stored in the data memory 222_0, the fourth data DT4 may be erased after being stored in an open block or a free block of the storage medium 300, not to be kept stored in the data memory 222_0.

At step S73, the fifth data DT5 stored in the second memory 222 may be transmitted to the parity generator 230. As shown, the fifth data DT5 may be transmitted to the storage medium 300 by the control of the control unit 210, and the control unit 210 may obtain an attribute IN F_char of the fifth data DT5 which is to be transmitted to the storage medium 300 and control the same fifth data DT5 to be transmitted to the parity generator 230.

At step S74, the fourth parity information PT4 stored in the parity memory 222_1 of the second memory 222 may be transmitted to the parity generator 230 by the control of the control unit 210. The fourth parity information PT4 may mean parity information on the fourth data DT4.

According to an embodiment, a sequence in which the parity generator 230 receives data and previous parity information may be changed. Namely, in FIG. 7, the sequence of the step S73 and the step S74 may be changed, and thus, the fifth data DT5 may be transmitted to the parity generator 230 after the fourth parity information PT4 is transmitted to the parity generator 230.

At step S75, based on the fourth parity information PT4 and the fifth data DT5, the parity generator 230 may generate fifth parity information PT5 on the fourth data DT4 and the fifth data DT5. The parity generator 230 may generate parity information based on a result of performing a logic calculation, for example, an exclusive-OR calculation, for data chunks.

As another embodiment, the fifth data DT5 transmitted from the storage medium 300 may not be stored in the data memory 222_0, and the parity generator 230 may receive the fifth data DT5 and then generate fifth parity information PT5 based on the fourth parity information PT4 received from the parity memory 222_1 and the fifth data DT5. In other words, the step S72 and the step S73 may be omitted.

At step S76, the generated fifth parity information PT5 may be transmitted to the second memory 222, and, at step S77, the fifth parity information PT5 may be stored in the second memory 222. For example, the second memory 222 may include the parity memory 222_1 which stores parity information, and the control unit 210 may control the fifth parity information PT5 to be stored in the parity memory 222_1 of the second memory 222.

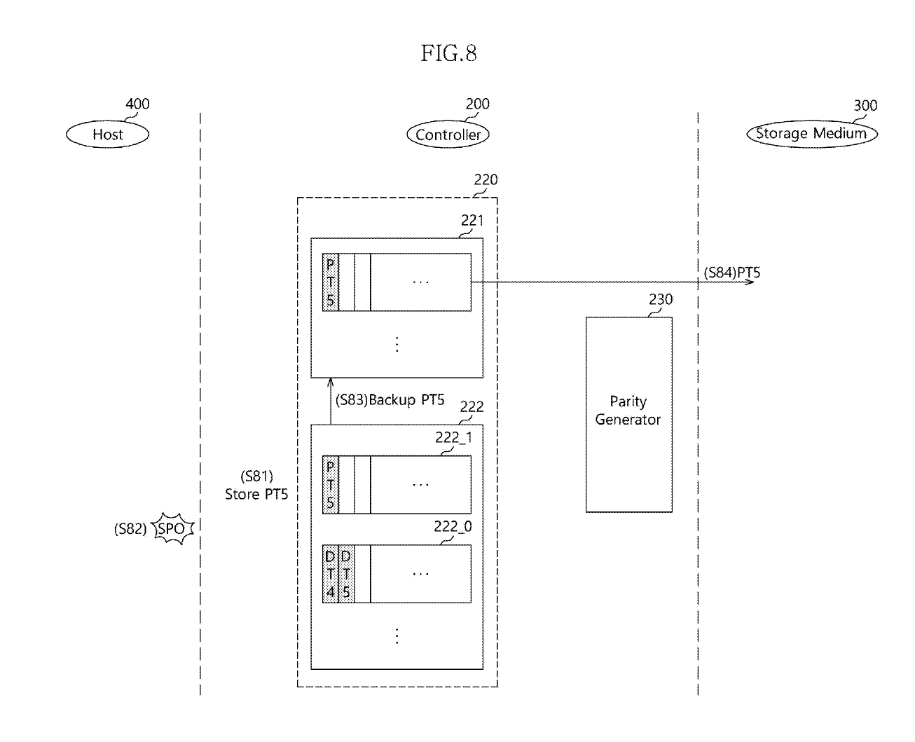

FIG. 8 is a representation of an example of a diagram to assist in the explanation of a process in which parity information is stored in another memory when a sudden power-off occurs while the parity information is stored in a memory in a garbage collection process. It is assumed that, as described above with reference to FIG. 6, fourth parity information PT4 on fourth data DT4 is stored in the second memory 222. Hereunder, with reference to FIGS. 2, 6 and 8, a process in which a parity information is stored when a sudden power-off occurs while the parity information of data as the target of garbage collection is stored in a memory, in accordance with an embodiment, will be described below.

In FIG. 8, it is assumed that the steps S71 to S76 described above with reference to FIG. 7 are applied in the same manner. That is to say, it is assumed that fifth data DT5 as the target of garbage collection is received by the controller 200 and a fifth parity information PT5 on the fourth data DT4 and the fifth data DT5 is generated by the parity generator 230 and is received by the second memory 222.

At step S81, the fifth parity information PT5 may be stored in the parity memory 222_1 included in the second memory 222. At step S82, an unexpected power supply interruption, that is, a sudden power-off SPO, may occur in the process in which the fifth parity information PT5 is stored in the parity memory 222_1. While it is described in FIG. 8 that a sudden power-off occurs in the process of performing a garbage collection operation, this is for an illustration purpose only and the same principle may be applied in the case where a sudden power-off occurs in all situations in which parity information is stored in the second memory 222.

According to the embodiment, the first memory 221 and the second memory 222 may be configured by volatile memories. A volatile memory is a memory which may lose data when power is cut off, and includes a DRAM or an SRAM. The memory system 10 may be supplied with power by using an auxiliary power supply when a sudden power-off occurs in a main power supply. By using the auxiliary power supply, data loss due to the sudden power-off may be reduced. However, since there is a limit in the power supplied by the auxiliary power supply, in order to prevent data loss, an operation of quickly backing up the data stored in a volatile memory device to a nonvolatile memory device is required.

At step S83, the control unit 210 may control the fifth parity information PT5 stored in the parity memory 222_1 to be backed up to the first memory 221. The first memory 221 may be relatively higher in data transmission rate than the second memory 222. In the case where the parity information stored in the second memory 222 is backed up to the first memory 221 according to the embodiment when a sudden power-off occurs, the parity information may be more quickly transmitted to the storage medium 300 by the first memory 221 which has a relatively higher data transmission rate than the second memory 222, and due to this fact, the possibility of parity information to be lost may be decreased. Also, since the second memory 222 may include the parity memory 222_1 and the data memory 222_0, when a sudden power-off occurs, the second memory 222 may transmit the data stored in the data memory 222_0 to the storage medium 300, and the first memory 221 may transmit the parity information to the first memory 221, whereby it may be possible to more efficiently prevent data loss.

At step S84, the controller 200 may control the fifth parity information PT5 stored in the first memory 221 to be transmitted to the storage medium 300. If necessary, not only the parity information stored in the first memory 221 but also the parity information or data stored in the second memory 222 may be controlled to be transmitted to the storage medium 300.

According to an embodiment, the first memory 221 may be a memory of which data transmission rate is relatively higher than the second memory 222. For example, the first memory 221 may be configured by an SRAM, and the second memory 222 may be configured by a DRAM.

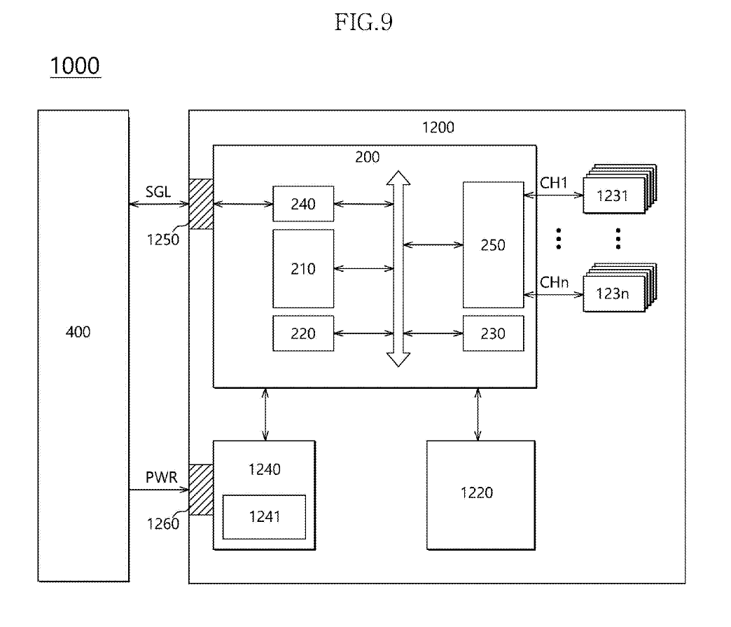

FIG. 9 is a diagram illustrating a representation of an example of a data processing system including a solid state drive (SSD) in accordance with an embodiment. Referring to FIG. 9, a data processing system 1000 may include a host device 400 and an SSD 1200.

The SSD 1200 may include a controller 200, a buffer memory device 1220, nonvolatile memory devices 1231 to 123n, a power supply 1240, a signal connector 1250, and a power connector 1260.

The controller 200 may control the general operations of the SSD 1200. The controller 200 may include a control unit 210, a random access memory 220, a parity generator 230, a host interface unit 240 and a memory control unit 250.

The host interface unit 240 may exchange a signal SGL with the host device 400 through the signal connector 1250. The signal SGL may include a command, an address, data, and so forth. The host interface unit 240 may interface the host device 400 and the SSD 1200 according to the protocol of the host device 400. For example, the host interface unit 240 may communicate with the host device 400 through any one of standard interface protocols such as secure digital, universal serial bus (USB), multimedia card (MMC), embedded MMC (eMMC), personal computer memory card international association (PCMCIA), parallel advanced technology attachment (DATA), serial advanced technology attachment (SATA), small computer system interface (SCSI), serial attached SCSI (SAS), peripheral component interconnection (PCI), PCI express (PCI-E) and universal flash storage (UFS),

The control unit 210 may analyze and process a signal SGL inputted from the host device 400. The control unit 210 may control the operations of internal function blocks according to a firmware or a software for driving the SSD 1200. The random access memory 220 may be used as a working memory for driving such a firmware or software.

The memory control unit 250 may provide control signals such as commands and addresses to the nonvolatile memory devices 1231 to 123n, according to the control of the control unit 210. Moreover, the memory control unit 250 may exchange data with the nonvolatile memory devices 1231 to 123n, according to the control of the control unit 210. For example, the memory control unit 250 may provide the data stored in the buffer memory device 1220, to the nonvolatile memory devices 1231 to 123n, or provide the data read out from the nonvolatile memory devices 1231 to 123n, to the buffer memory device 1220.

The buffer memory device 1220 may temporarily store data to be stored in the nonvolatile memory devices 1231 to 123n. Further, the buffer memory device 1220 may temporarily store the data read out from the nonvolatile memory devices 1231 to 123n. The data temporarily stored in the buffer memory device 1220 may be transmitted to the host device 400 or the nonvolatile memory devices 1231 to 123n according to the control of the controller 200.

The nonvolatile memory devices 1231 to 123n may be used as storage media of the SSD 1200. The nonvolatile memory devices 1231 to 123n may be coupled with the controller 200 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured by various types of connectors depending on an interface scheme between the host device 400 and the SSD 1200.

The power connector 1260 may be configured by various types of connectors depending on a power supply scheme of the host device 400.

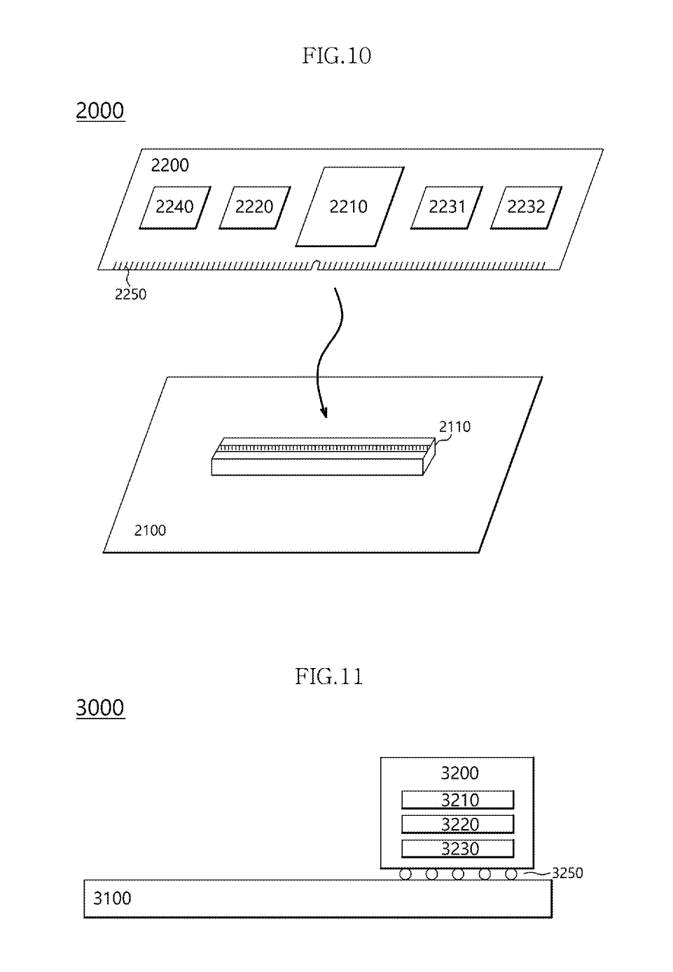

FIG. 10 is a diagram illustrating a representation of an example of a data processing system including a memory system in accordance with an embodiment. Referring to FIG. 10, a data processing system 2000 may include a host device 2100 and a memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control the general operations of the memory system 2200. The controller 2210 may be configured in the same manner as the controller 200 shown in FIG, 9.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to the control of the controller 2210.

The nonvolatile memory devices 2231 and 2232 may be used as the storage media of the memory system 2200.

The PMIC 2240 may provide the power inputted through the connection terminal 2250, to the inside of the memory system 2200. The PMIC 2240 may manage the power of the memory system 2200 according to the control of the controller 2210.

The connection terminal 2250 may be coupled to the connection terminal 2110 of the host device 2100. Through the connection terminal 2250, signals such as commands, addresses, data and so forth and power may be transferred between the host device 2100 and the memory system 2200. The connection terminal 2250 may be constructed into various types depending on an interface scheme between the host device 2100 and the memory system 2200. The connection terminal 2250 may be disposed on any one side of the memory system 2200.

FIG. 11 is a diagram illustrating a representation of an example of a data processing system including a memory system in accordance with an embodiment. Referring to FIG. 11, a data processing system 3000 may include a host device 3100 and a memory system 3200.

The host device 3100 may be configured in the form of a board such as a printed circuit board. Although not shown, the host to device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control the general operations of the memory system 3200. The controller 3210 may be configured in the same manner as the controller 200 shown in FIG. 9.

The buffer memory device 3220 may temporarily store data to be stored in the nonvolatile memory device 3230. Further, the buffer memory device 3220 may temporarily store the data read out from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

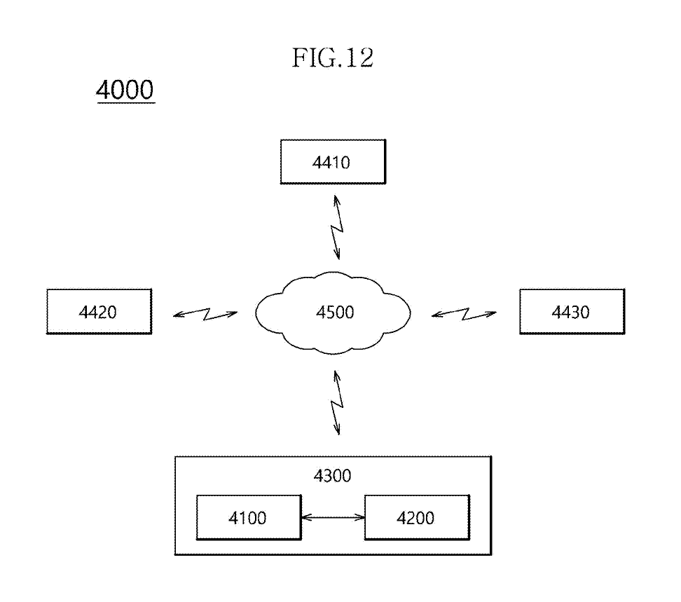

FIG. 12 is a diagram illustrating a representation of an example of a network system including a memory system in accordance with an embodiment. Referring to FIG. 12, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured to include the memory system 10 of FIG. 1, the SSD 1200 of FIG. 9, the memory system 2200 of FIG. 10 or the memory system 3200 of FIG. 11.

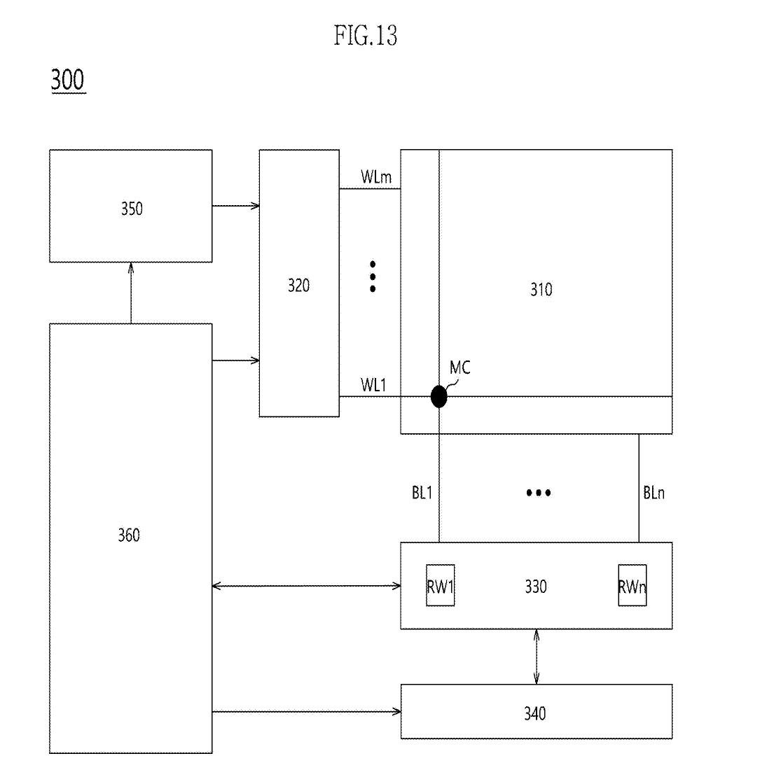

FIG. 13 is a block diagram illustrating a representation of an example of a nonvolatile memory device included in a memory system in accordance with an embodiment. Referring to FIG. 13, a nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to the control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to the control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to the control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines (or data input/output buffers), based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For still another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control the general operations of the nonvolatile memory device 300, based on control signals provided from the external device. For example, the control logic 360 may control the read, write and erase operations of the nonvolatile memory device 300.

While various embodiments have been described above, it will be understood to those skilled in the art that the embodiments described are examples only. Accordingly, the memory system described herein should not be limited based on the described embodiments.

What is claimed is:

1. A memory system comprising:
a memory control unit;
a first memory;
a second memory having a characteristic different from the first memory;
a data attribute determination circuit configured to determine an attribute of data to be transmitted through the memory control unit; and
a memory selection circuit configured to selectively store parity information on the data in the first memory or the second memory, based on the attribute of the data.

2. The memory system according to claim 1, wherein the parity information is generated by using previous parity information stored in a memory selected between the first memory and the second memory.

3. The memory system according to claim 1, wherein the first memory and the second memory have different data transmission rates.

4. The memory system according to claim 1,
wherein the first memory is configured as a memory having relatively faster access time or relatively higher bandwidth, and the second memory is configured as a plurality of memories having relatively slower access time or relatively lower bandwidth.

5. The memory system according to claim 1,
wherein the data attribute determination circuit determines the attribute of the data based on whether the data is host data or not, and
wherein the memory selection circuit selectively stores the parity information in the first memory or the second memory, based on the attribute of the data.

6. The memory system according to claim 1,
wherein the data attribute determination circuit determines the attribute of the data based on whether the data is hot data or cold data, and
wherein the memory selection circuit selectively stores the parity information in the first memory or the second memory, based on the attribute of the data.

7. The memory system according to claim 6, wherein the memory selection circuit selectively stores the parity information in the first memory or the second memory according to whether the data is hot data or cold data, when the data is host data.

8. The memory system according to claim further comprising:
a storage medium configured to receive and store the data transmitted through the memory control unit.

9. A memory system comprising:
a memory control unit;
a first memory;
a second memory having a characteristic different from the first memory, and configured to buffer data to be transmitted through the memory control unit;
a parity generator configured to generate parity information for the data; and
a control unit configured to control the parity generator to store the parity information in any one of the first memory and the second memory,
wherein the control unit includes a data attribute determination circuit configured to determine an attribute of the data and a memory selection circuit configured to select any one of the first memory and the second memory as a memory in which the parity information is to be stored, based on the attribute of the data.

10. The memory system according to claim 9, wherein the parity generator generates the parity information by using previous parity information stored in a memory selected between the first memory and the second memory.

11. The memory system according to claim 9, wherein the first memory has a data transmission rate relatively higher than the second memory.

12. The memory system according to claim 9,
wherein the data attribute determination circuit determines the attribute of the data according to whether the data is hot data or cold data, and
wherein the memory selection circuit selects any one of the first memory and the second memory based on the attribute of the data.

13. The memory system according to claim 12, wherein the memory selection circuit selects any one of the first memory and the second memory according to whether the data is hot data or cold data, when the data is host data.

14. The memory system according to claim 12, wherein the memory selection circuit selects the first memory as a memory in which the parity information is to be stored, when the data is hot data.

15. The memory system according to claim 12, wherein the memory selection circuit selects the second memory as a memory in which the parity information is to be stored, when the data is cold data.

16. The memory system according to claim 9, wherein, when a sudden power-off occurs in a state in which the parity information is stored in the second memory, the control unit copies the parity information stored in the second memory to the first memory and controls the parity information stored in the first memory to be transmitted to the storage medium.

17. The memory system according to claim 9,
wherein the data attribute determination circuit determines the attribute of the data according to whether the data is host data or not, and
wherein the memory selection circuit selects any one of the first memory and the second memory based on the attribute of the data.

18. The memory system according to claim 17, wherein the memory selection circuit selects the first memory as a memory in which the parity information is to be stored, when the data is host data.

19. The memory system according to claim 17, wherein the memory selection circuit selects the second memory as a memory in which the parity information is to be stored, when the data is not host data.

20. The memory system according to claim 9, further comprising:
a storage medium configured to receive and store the data transmitted through the memory control unit.

21. A memory system comprising:
a first memory;
a second memory having a data transmission rate lower than the first memory, and configured to buffer data to be transmitted through the memory control unit;
a parity generator configured to generate parity information for the data;
a data attribute determination circuit configured to determine an attribute of the data; and
a memory selection circuit configured to selectively store the parity information in the first memory or the second memory, based on the attribute of the data,
wherein the memory selection circuit stores the parity information in the second memory when the data is cold data or rewrite data.

22. The memory system according to claim 21, wherein the memory selection circuit stores the parity information in the first memory when the data is hot data.

23. The memory system according to claim 21, wherein the memory selection circuit stores the parity information in the first memory when the data is host data.
